(19) United States
(12) Patent Application Publication
(10) Pub. No.: US 2025/0112875 A1
(43) Pub. Date: Apr. 3, 2025

(54) SYSTEM AND METHOD FOR ORGANIZING PHYSICAL QUEUES INTO VIRTUAL QUEUES

(71) Applicant: TELEFONAKTIEBOLAGET LM ERICSSON (PUBL), Stockholm (SE)

(72) Inventors: Amir Roozbeh, STOCKHOLM (SE); Alireza Farshin, STOCKHOLM (SE); Dejan Kostic, SOLNA (SE)

(73) Assignee: TELEFONAKTIEBOLAGET LM ERICSSON (PUBL), Stockholm (SE)

(21) Appl. No.: 18/728,440

(22) PCT Filed: Jan. 19, 2022
(86) PCT No.: PCT/EP2022/051103

§ 371 Date: Jul. 11, 2024

(51) Int. Cl. H04L 49/00; H04L 49/90

(52) U.S. Cl. CPC H04L 49/3045; H04L 49/3009; H04L 49/9078

(57) ABSTRACT

A method of buffering data packets at a network device includes receiving a set of data packets from an ingress port of the network device, identifying primary information and secondary information about each data packet in the set of data packets, determining a virtual queue for each data packets in the set of data packets based on the primary information, the virtual queue having a set of physical queues, determining a physical queue from the set of physical queues for each of the data packets in the set of data packets based on the secondary information, and storing the set of data packets in physical queues of the virtual queue.

### TECHNICAL FIELD

Embodiments of the invention relate to the field of network device operation; and more specifically, to the queuing of data packets in network devices.

### BACKGROUND ART

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

A switch is an example of a network device that connects other devices together as part of a network. A switch can include ports where data cables are plugged to enable communication with other devices that are plugged into the other end of the data cables. Similarly, the switches can have wireless capability where radio signals are utilized to communicate with other devices in place of the data cables. Switches can manage the flow of data across a network by receiving and forwarding data in the form of data packets. Generally, the data packets include headers with destination addresses. The switch uses the destination address to determine a next ‘hop’ for the data packet using forwarding tables. The data packet is then forwarded to the next hop toward the destination of the data packet where the next hop can be reached by a port of the switch that connects the switch to the next hop by a data cable or wireless connection.

A switch is more intelligent than a hub or similar network devices that retransmit received data packets out of every port of the hub except the port on which the packet was received. The hubs do not maintain forwarding tables or have knowledge of the network and are unable to perform more complex forwarding or decision making.

A switch can operate at the data link layer. The data link layer is layer 2 of the Open systems Interconnection (OSI) reference model. Switches can also operate at higher layers of the OSI model, including the network layer and above. A switch that also operates at these higher layers is referred to as a multilayer switch.

### SUMMARY

In one embodiment, method of buffering data packets at a network device includes receiving a set of data packets from an ingress port of the network device, identifying primary information and secondary information about each data packet in the set of data packets, determining a virtual queue for each data packets in the set of data packets based on the primary information, the virtual queue having a set of physical queues, determining a physical queue from the set of physical queues for each of the data packets in the set of data packets based on the secondary information, and storing the set of data packets in physical queues of the virtual queue.

In another embodiment, a machine-readable medium includes computer program code which when executed by an electronic device causes the electronic device to carry out the method of buffering data packets at a network device. The method includes receiving a set of data packets from an ingress port of the network device, identifying primary information and secondary information about each data packet in the set of data packets, determining a virtual queue for each data packets in the set of data packets based on the primary information, the virtual queue having a set of physical queues, determining a physical queue from the set of physical queues for each of the data packets in the set of data packets based on the secondary information, and storing the set of data packets in physical queues of the virtual queue.

In a further embodiment, an electronic device performs the method of buffering data packets. The electronic device includes a system memory, a processor, and a network interface card. The network interface card is configured to perform the method of buffering data packets. The method includes receiving a set of data packets from an ingress port of the network device, identifying primary information and secondary information about each data packet in the set of data packets, determining a virtual queue for each data packets in the set of data packets based on the primary information, the virtual queue having a set of physical queues, determining a physical queue from the set of physical queues for each of the data packets in the set of data packets based on the secondary information, and storing the set of data packets in physical queues of the virtual queue.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a network interface card.

FIG. 2 is a diagram of one example embodiment of a network device with NICs that support virtual queueing.

FIG. 3 is a flowchart of one embodiment of a process for initializing the virtual queue management.

FIG. 4 is a flowchart of one embodiment of a process for data packet reception.

FIG. 5 is a flowchart of one embodiment of a process for polling.

FIG. 6 is a diagram of one embodiment of a process of using interrupts to manage I/O events.

FIG. 7A is a timing diagram of one embodiment illustrating the operation of components of processes for virtual queue management during the initialization phase.

FIG. 7B is a timing diagram of one embodiment illustrating the operation of components of processes for virtual queue management during the packet receiving phase.

FIG. 7C is a timing diagram of one embodiment illustrating the operation of components of processes for virtual queue management during a polling request phase.

FIG. 8A illustrates connectivity between network devices (NDs) within an exemplary network, as well as three exemplary implementations of the NDs, according to some embodiments of the invention.

FIG. 8B illustrates an exemplary way to implement a special-purpose network device according to some embodiments of the invention.

FIG. 8C illustrates various exemplary ways in which virtual network elements (VNEs) may be coupled according to some embodiments of the invention.

FIG. 8D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 8E illustrates the simple case of where each of the NDs implements a single NE, but a centralized control plane has abstracted multiple of the NEs in different NDs into (to represent) a single NE in one of the virtual network(s), according to some embodiments of the invention.

FIG. 8F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 9 illustrates a general-purpose control plane device with centralized control plane (CCP) software 950), according to some embodiments of the invention.

### DETAILED DESCRIPTION

The following description describes methods and apparatus for a method of managing queues in a network device. The embodiments provide a method of virtualized queueing that enables multiple physical queues to be associated with a single virtual queue. The processor can interact with the single virtual queue to process received data packets and thus reduce the processing and resource overhead for data packet processing. In addition, the virtual queueing process improves the usage of available physical queues.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate-level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Network devices are continually improving by adding support for faster link speeds and lower latency processing to meet the need for having low-latency and high-throughput Internet services. These improvements have resulted in fundamental changes in networking devices and the components therein such as network interface cards (NIC). The improvements to network devices include software and operational changes including the development of OpenFlow-enabled switches, programmable (P4-enabled) switches, smart NICs, and field programmable gate array (FPGA) NICs.

These improvements in network devices offers system developers more programmability and offloading capabilities, enabling the network devices to perform various types of packet processing at earlier stages in different parts of the network. Additionally, improvements in NICs include the support for more advanced features such as multi-receive (RX)/transmit (TX) queues, flow steering capabilities (e.g., Receive Side Scaling (RSS)), virtualization support (e.g., Single Root I/O Virtualization SR-IOV), and transmission control protocol (TCP)/Internet Protocol (IP) offloading capabilities (e.g., TSO (TCP segmentation offload), GRO (Generic Receive Offload), and LRO (Large Receive Offload)), which facilitate deploying low-latency services at multi-hundred-gigabit rates and beyond.

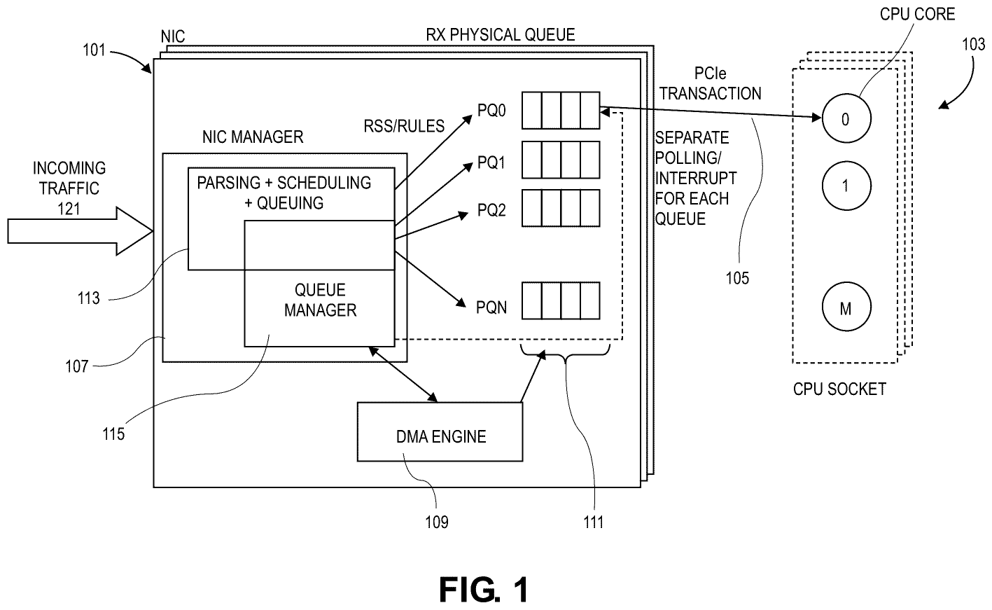

FIG. 1 is a diagram of one embodiment of a network interface card. A network interface card (NIC) is an interface (i.e., a component) in an electronic device, such as a network device, used to receive/send packets via a network. NICs can be connected to a central processing unit (CPU) or similar processor via an interconnect on a printed circuit board (e.g., a peripheral component interconnect express (PCIe) interconnect on a motherboard. A NIC is provided by descriptors, i.e., including a set of addresses to be used to send and receive data to and from system memory. A NIC is composed of different modules in order to perform its operation. The example embodiment of a NIC is provided by way of example and not limitation. Those skilled in the art would understand that the features and functions described in connection with a NIC can be implemented in other components of a network device or similar electronic device.

In some embodiments, the networking device includes a set of NICS 101 and a set of processors 103 connected by an interconnect 105. Each NIC 101 can include or support a set of wired or wireless ports 121 where data packets are received from other electronic devices. Each NIC 101 can include a NIC manager 107 that includes parsing, scheduling, and queueing functions 113, a queue manager 115, or similar functions or components that manage the receipt and queueing of incoming data packets (i.e., incoming traffic). The incoming data packets are stored in a set of physical queues 111, which can be specialized buffers or similar storage devices where the incoming data packets are stored until they can be processed by the set of processors 103.

In some embodiments, a direct memory access (DMA) engine 109 can interact with the NIC manager 107, the set of physical queues 111, system memory (not shown), and similar components to transfer the data packets from the set of physical queues 111 to a location where they can be processed by the set of processors 103 (e.g., in system memory or other memory storage accessible to the set of processors 103). The network device can include any number of processors 103. The set of processors 103 can include any number and type of processors including general-purpose processors, application specific integrated circuits (ASICs), and similar processors. Each processor 103 can include a set of cores that separately can be assigned to process data packets or can work in combination to process data packets. The set of processors 103 can interface with the other components of the network device via a socket or similar interface. The processors 103 can communicate with the NICs 101 and similar components using a bus or similar interconnect. In one example embodiment, the interconnect is a peripheral component interconnect express (PCIe).

In some embodiments, the NIC manager 107 is a software or hardware component of the NIC that performs tasks including packet classification, packet filtering, scheduling, and queuing. The NIC manager decides how an incoming packet should be distributed among available receiver (RX) queues, The RX queues provide the data packet to the processor or other components of network device directly or indirectly (e.g., by DMA engine 109).

The physical queues 111 in the NIC are buffers used to temporarily store incoming data packets, and are also referred to as RX queues. In some embodiment, these physical queues 111 or a separate set of physical queues can store the outgoing data packets and can be referred to as transmission (TX) queues. NICs can include multiple physical queues for RX/TX, each of which is identified by a locally or globally unique identifier (ID). In the example, the physical queues 111 are labeled PQ1, PQ2, . . . , PQN. The NIC can include any number, size, or variety of physical queues 111.

The DMA engine 109 is software and/or hardware responsible for transferring data packets to and from a system memory. The DMA engine 109 uses the information in descriptors and the address of buffers (i.e., the physical queues) that is stored in the system memory to determine which data packets to transfer from the physical queues to the system memory. In addition, the DMA engine 109 can be seen as the communication gateway between the NIC and the other components of the network device, meaning that all messages to/from different components of the NIC and between separate NICs and other components of the network device can be received/sent via DMA engine 109.

The parsing and/or scheduling component 113 can parse the incoming data packets prior to storage in the physical queues 111. The parsing and/or scheduling component 113 can identify the type of the received data packets and the information encapsulated in the data packet headers required for packet classification. For instance, when a NIC expects to receive Ethernet packets, the parsing component identifies different layer-2 headers (e.g., source/destination MAC addresses), layer-3 headers (e.g., source/destination IP addresses), and layer-4 headers (e.g., UDP/TCP ports). In some embodiments, devices/NICs may support other protocols such as Infiniband. The parsing and/or scheduling module uses the extracted information from a packet and the pre-defined policy to classify packets into different groups and store them in different RX queues. The queue manager 115 manages the physical queues 111. More specifically, the queue manager 115 keeps track of their number of descriptors and the available addresses for physical queues provided for the processors 103 (i.e., to be used by the DMA engine 109 to transfer the data packets). The queue manager 115 interacts with the parsing and scheduling component 113 to enable flow steering capabilities and data packet classification (i.e., distribution of incoming packets among the queues). The queue manager 115 enables the DMA engine 109 to send/receive data from the main system memory that is organized as the processors' 103 memory address space.

The embodiments provide a process to improve the usage of multi-RX/TX physical queues in NICs or similar components of network devices and other similar electronic devices. Having multiple physical queues enables NICs to interact with multiple processors and/or multiple processor cores (i.e., both physical and logical cores) and to send/receive simultaneous traffic (e.g., data packets) to/from the host processor, improving the packet per second (PPS) and Input/Output (I/O) performance. There are generally two mechanisms for processors to receive data packets from the NIC physical queues, interrupts and polling.

Interrupts are one mechanism to receive packets from an I/O device. In cases where interrupts are utilized, operating systems (e.g., the Linux kernel) associate each physical queue of the NIC (i.e., those functioning as RX queues) with an interrupt number that can be processed by fixed or different processors or processor cores. When a data packet arrives in an RX queue and is then transferred by the DMA engine 109 to the system memory, the NIC (e.g., the NIC manager 107 or DMA engine 109) raises an interrupt to the operation system. Then a processor or processor core starts further processing of the data packet by accessing it in the system memory where it has been transferred by the DMA engine 109. However, using interrupts imposes significant overhead on packet processing when shifting toward faster link speeds. Where a separate interrupt is utilized for each physical queue, this also utilizes a significant number or variety of interrupt types or operands that add complexity to the interrupt handling.

Polling is another mechanism for transferring data packets to the processors or processor cores. Networking applications can use kernel-bypass frameworks (e.g., data plane development kit (DPDK)) to overcome interrupts' performance overhead. Unlike interrupt-based operating system solutions, these frameworks actively poll different RX physical queues 111 at the NIC and ask for data packets to be processed. These frameworks assume that physical queues will not be empty at high frequency. By doing so, these frameworks mitigate the interrupt limitations at high speeds and achieve much higher performance at >100-Gbps rates. To poll each RX queue 111, the system (i.e., via device driver (aka poll mode driver)) sends a PCIe message to the NIC and requests data packets up to a certain number (aka an I/O burst size). The NIC replies with the number and addresses of the successfully transferred (by the DMA engine 109) packets from the NIC to the processor memory or cache. There can be different implementations for realizing polling in the network device and the NIC. For instance, in some embodiments, the NIC can update (via DMA) the value of the I/O operation status (e.g., the RX queue ring head) in the memory or cache of the network device. For example, a data structure in the memory or cache of the network device can be maintained that indicates data packets have been transferred by the DMA engine to the memory. Consequently, the poll mode driver repeatedly checks the status value in the cache or memory instead of performing PCIe reads. The polling mechanisms are provided by way of example and not limitation.

Although a network device and the component NICs can provide a large number of physical queues (e.g., 512 RX/TX physical queues), applications (both Linux-based and kernel-bypass) typically limit the number of active queues to the number of available processors 103 or processor cores that is much smaller than the number of available physical queues 111, where each RX physical queue is checked by one processor 103 or processor core. While it is possible to use more RX/TX physical queues in these network devices and NICS, in practice, applications refrain from doing so, because using a large number of physical queues imposes latency overhead on the application performance due to longer queuing time and/or extra PCIe overhead. For example, when a single-core application polls more than one RX physical queue, it has to inquiry/poll each physical queue separately in an interactive loop. In each iteration, the processor 103 or core sends a PCIe transaction to the NIC 101 for one RX physical queue 111 and then waits for a response. Upon receiving a response, the processor 103 or core may immediately go to the next iteration (i.e., polling another RX physical queue 111), or the processor 103 or core may continue processing the received packets from the current RX physical queue before continuing to the next iteration. High-performance networking applications usually follow the latter case to batch processing and improve cache locality, i.e., amortizing the cost of running the same instructions on multiple packets (aka a batch of packets).

The embodiments provide methods and a system to increase the practical utilization of a large number of physical queues 111. There are many advantages in using more physical queues per core. NICs 101 are shipped with flow steering capabilities that enable applications to define/install rules matching the incoming packets (e.g., using five tuples) on the NIC to distribute them among different queues. Using more queues makes it possible to distribute packets in a more fine-grained way, which could help applications to offload more classification logic into the NIC 101. Using only one queue per core or processor 103 may result in suboptimal performance. When a single-core processor 103 or a single core performs L2 forwarding, it can forward packets at ˜120 Gbps with two RX physical queues, whereas a single RX physical queue could only achieve ˜90 Gbps. Therefore, devising an efficient way to use more RX physical queues (without imposing additional overhead and sacrificing latency) could improve the performance of high-performance networking applications.

Each RX physical queue 111 at the NIC 101 has a limited length, i.e., it can only receive a limited number of descriptors (buffer addresses) from the NIC driver. However, having a higher number of physical queues 111 and a higher number of descriptors at higher rates (e.g., 200/400 Gbps) can be utilized, because the traffic will be more bursty, requiring more buffers at the NIC 101 and more descriptors to transfer incoming data packets to the system memory. Using more RX physical queues can address this problem, and the embodiment provide a method and system to make the use of a large number of physical queues feasible and scalable.

The embodiments can be utilized in conjunction with other types of virtualization including SR-IOV. SR-IOV is an extension to the PCIe specification, which enables I/O devices to expose themselves to hosts with multiple PCIe addresses (i.e., Bus:Device:Function (BDF)). By doing so, a single I/O device can directly be connected to different virtual machines (VMs) as it could be accessed by multiple different PCIe addresses with different function values, aka virtual function. Therefore, SR-IOV does not provide any solutions/methods for bundling multiple physical queues into one “virtual” queue. The embodiments provide virtual queues for receiving/sending packets between an I/O device (e.g., a NIC 101) and the processors 103.

Thus, the embodiments address several deficiencies in the art. Current NICs do not provide a way to efficiently use multiple queues per processor or core. Polling multiple RX physical queues 111 per core could increase throughput, but at the cost of higher latency. Polling multiple RX physical queues 111 can be done in an iterative loop, which requires multiple PCIe transactions that impose extra latency overhead and uses resources inefficiently. NICs 101 do not provide an efficient (overhead-free) way to use all the available resources (e.g., rule-based packet steering and queues) on the NIC 101.

The embodiments overcome these limitations and deficiencies of the art. The embodiments provide a system and process for queue management that can be implemented in ae NIC 101 or similar component of a network device. The embodiments can efficiently use more of the physical queues 111 (e.g., of a NIC 101) without incurring the extra overhead of queuing and PCIe transactions penalties in the prior art. In particular, the embodiments improve NIC 101 or physical queue 111 management functionalities to enable the creation of virtual/logical queues (referred to herein as ‘virtual queues’) that are backed by multiple physical queues 111. The embodiments thereby enable applications to seamlessly benefit from having more physical queues 111 without requiring any modifications to the function of the applications.

More specifically, the embodiments enable applications and the other aspects of the network device to interact with the NIC 101 via virtual queue identifiers (IDs) rather than physical queue IDs, where each virtual queue is connected/composed to/of multiple physical queues 111 with each physical queue assigned a certain weight that indicates a relative proportion or priority of the data packets stored within the set of physical queues 111 associated with a virtual queue. When a NIC 101 receives a polling request for a virtual queue ID from the software or hardware of the network device (e.g., a device driver), the NIC manager 107 polls multiple physical queues 111 based on the weight list (and/or similar priority criteria) and provides data packets of multiple physical queues 111 (up to a certain number of data packets) to the system (e.g., device driver). By doing so, applications can effectively receive more data packets, as the probability of polling an empty (virtual) queue would be lower. Moreover, applications can send a single polling request (or receive a single interrupt) for multiple physical queues 111, whereas the prior art NICs require applications to perform multiple inquiries in a similar scenario.

The embodiments introduce the concept of virtual/logical queues that opens new opportunities for offloading data packet classification functions to the NIC. More specifically, applications, users, and similar entities can define rules for either virtual queues or their underlying physical queues. The embodiments introduce methods to efficiently offload (or define rules) on a NIC with virtual queues. The embodiments provide a system and methods for bundling multiple physical queues and creating virtual queues on a NIC 101 or similar component containing at least two physical queues. In addition, the embodiments provide a method of efficiently applying rules on virtual queues to ensure faster rule marching or implementation.

The embodiments provide many advantages over the art and introduce the concept of polling multiple physical queues 111 simultaneously by grouping them as virtual queues. The embodiments also enable network devices and similar electronic devices to use all the available physical queues on NICs 101 or similar components regardless of the number of available processors 103 or processor cores. The embodiments make it possible to achieve a higher performance (i.e., high throughput and lower latency) at multi-hundred-gigabit rates for data packet handling. The embodiments provide a system and methods for bundling the physical queues 111 and creating virtual queues, which facilitates data packet classification offloading and results in a fair usage of available resources. The embodiments provide methods for defining data packet steering rules at different granularities for both virtual queues and physical queues 111 to fully benefit from the introduction of virtual queue concept.

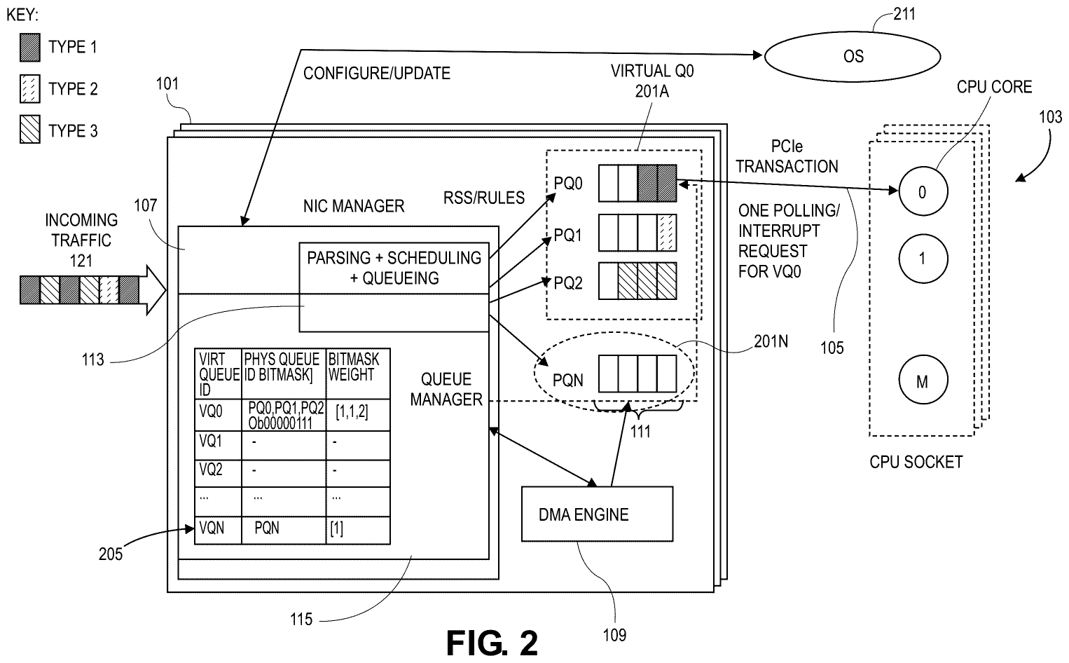

FIG. 2 is a diagram of one example embodiment of a network device with NICs that support virtual queueing. The embodiments update or extend the queue manager 115 entity of the NIC 101 to enable creation of virtual queues (VQ) 201A-N. At the hardware (H/W) level, the embodiments extend the queue manager 115 with a set of tables providing information regarding how the virtual queues (VQs) are shaped/created/configured including how they are associated with physical resources including the set of physical queues 111. Table I is an example virtual queue management table that contains at least three columns, i.e., virtual queue ID, physical queue IDs(s), and weight. This table (Table I) can be an extension to an already-available table/data structure in the queue manager 115, which contains information regarding the number of descriptors and the buffer addresses received from the host. In other embodiments, the table (Table I) can be also implemented as a separate table/data structure.

TABLE I

| | Phys. Queue ID | |
|---|---|---|
| Virt. Queue ID | [bitmask] | Weight List |
| VQ0 | PQ0 (bx0000 . . . 001) | [1] |
| VQ1 | PQ1 (bx0000 . . . 010) | [1] |
| VQ2 | PQ2 (bx0000 . . . 100) | [1] |
| . . . | . . . | . . . |
| VQN | PQN (bx1000 . . . 000) | [1] |

In the example of Table I, a set of example or default values are shown, where each virtual queue (VQ1-VQN) is associated with only one physical queue (PQ1-PQN0, which is a one-to-one mapping). In this example table, the virtual queue ID is a column that represents the ID of each virtual queue. The physical queue ID(s) is a column that shows the physical queue (PQ) IDs that are associated with a virtual queue. In this example, bitmasks are used for the representation of the PQ IDs. By default, each virtual queue 201A-N can be connected to one physical queue 111 to remove the need for any further changes in the device driver and PCIe poll requests—i.e., all polling requests contain a VQ ID that is the same type and format of an ID as the PQ ID. However, in other embodiments it is possible to extend PCIe poll request to distinguish between VQ and PQ IDs. Furthermore, each physical queue 111 can only be connected to one virtual queue 201A-N at a given point in time to mitigate inconsistencies.

The weight column contains a list of weights for each PQ associated with a VQ. In some embodiments, by default, the weight of each PQ would be 1, and their data packets would be consumed equally. However, a user or application can define different weights for each physical queue. For example, a VQ (VQ0) connected to three PQs (PQ0-2) can have a weight list of [1,1,2] where PQ2 is provided twice the data packet throughput as PQ0 and PQ1. The PQs can be accessed/consumed via a weighted round robin or similar process. In other embodiments, more advanced or complex processes can be utilized to make the weight list more efficient. Fundamentally, there is no limitation in the number of entries for the second column. However, to address the scalability problem, one can limit each VQ 201A-N to be connected to a limited number of physical queues 111 to facilitate the implementation of the embodiments (via fewer bits or smaller data structures).

For example, Table II shows a sample version of the virtual queue management table 205 where each VQ can be connected to at most 8 physical queues, implemented as an 8-bit bitmask in the second column (i.e., X7 X6 X5 X4 X3 X2 X1 X0) where the value of Xi could be zero or one. The value 1 indicates that the PQi is part of a given VQ. In this specific example, 0b00000111 indicates that PQ2, PQ1, PQ0 are bundled together to create VQ0.

TABLE II

| Virt. Queue ID | Phys. Queue ID [bitmask] | Weight List |
|---|---|---|
| VQ0 | PQ2, PQ1, PQ0 (0b00000111) | [2, 1, 1] |
| VQ1 | — | — |
| VQ2 | — | — |
| . . . | . . . | . . . |
| VQN | PQN | [1] |

The embodiments provide a scalable process and mechanisms. In one example, a NIC has 512 physical queues. In an unscalable solution, using all of these physical queues would require a 512-bit bitmask to show whether a physical queue is part of a virtual queue or not, which may increase the resource consumption on the NIC. To address this problem, each virtual queue 201A-N can be limited to a range of physical queues 111. In one example, the 512 physical queues can be divided into 64 bundles of 8-queue packages, where each virtual queue can only be connected to a set of physical queues within that range—e.g., VQ0-7 can be connected to PQ0-7; VQ8-15 can be connected to PQ8-15, etc. In this example embodiment, there is a trade-off between using more physical queues 111 while not raising any implementation concerns. Each physical queue 111 can only be connected to one virtual queue; therefore, the XOR of bits within each bundle should be 1. In this example embodiment, VQi can be connected to physical queues 111 within the range of [(i−i mod 8),(i−i mod 8)+7]. For example, VQ11 can be connected to PQ[11−3,11−3+7]=PQ[8,15]. An example of the virtual queue management table for this example embodiment is shown below in Table III. In Table III, an example table for the scalable implementation with 8-queue bundles is shown, where VQ0 is connected to all physical queues in bundle 0 (i.e., PQ0-7). The rest of the virtual queues have their default value, and they are connected to their respective physical queues.

TABLE III

| Virt. Queue | | |
|---|---|---|
| ID | Phys. Queue ID [bitmask] | Weight List |
| VQ0 | PQ7, PQ6, PQ5, PQ4, PQ3, PQ2, PQ1, PQ0 | [1, 1, 1, 1, |
| (bundle 0) | 0b1111111 | 1, 1, 1] |
| VQ1 | — | — |
| (bundle 0) | | |
| VQ2 | — | — |
| (bundle 0) | | |
| VQ3 | — | — |
| (bundle 0) | | |
| VQ4 | — | — |
| (bundle 0) | | |
| VQ5 | — | — |
| (bundle 0) | | |
| VQ6 | — | — |
| (bundle 0) | | |
| VQ7 | — | — |
| (bundle 0) | | |
| VQ8 | PQ8 | [1] |
| (bundle 1) | 0b0000001 | |
| . . . | . . . | . . . |
| VQ511 | PQ511 | [1] |
| (bundle 63) | | |

An example is further described herein below with relation to FIG. 2 to illustrate the operation of the embodiments. The embodiments can be characterized has having three main phases (i) the initialization phase where the system is initialized and configured to utilize the proposed idea, (ii) the packet reception phase where the system performs actual tasks while handling the incoming traffic, and (iii) I\O event handling where the system is informed about the arrival of new packets.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

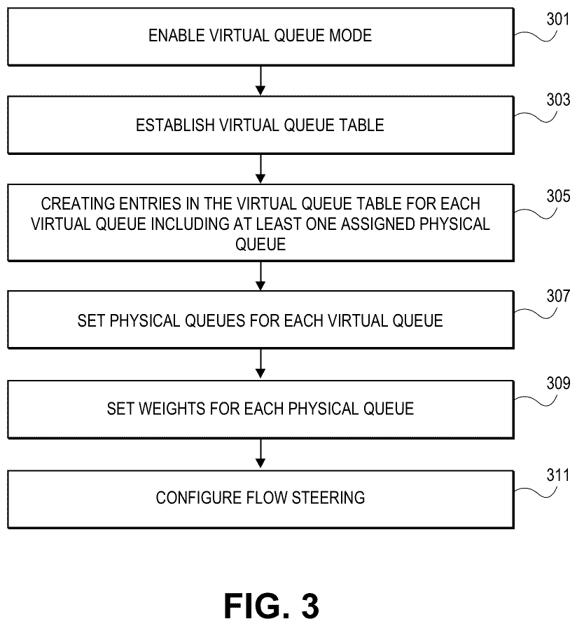

FIG. 3 is a flowchart of one embodiment of a process for initializing the virtual queue management. The example process describes the actions and functions to configure the NIC or similar component at the initialization phase. The initialization can be done either as part of a kernel-bypass framework (e.g., poll mode drivers of DPDK), by an operating system where the device driver is loaded into the kernel, or by similar software components. A system administrator, application, or similar entity interacts with the NIC (e.g., via a NIC driver or similar software) to enable a VQ mode (Block 301). In response to the enablement of the VQ mode, the NIC (e.g., the NIC manager 107 or queue manager 115) can set up/update the VQ table 205 on the NIC 101 (Block 303). In one example embodiment, a Linux user can use ethtool or a similar tool to configure the table. If an interrupt mechanism is to be used, the relevant configuration for setting up the interrupts for a given VQ can be set at this point.

At this stage, the user, application, NIC manager or similar entity can create entries for each VQ to specifying a PQ list for that VQ (Block 305). An entry for each VQ including a list of the associated PQs can be created (Block 307). Similarly, a weight (e.g., the 2nd and 3rd columns of the example tables) for each of the PQs in the list can be created for each VQ entry (Block 309).

In the example of FIG. 2, the virtual queue table 205 is configured with VQ0 connected to PQ0, PQ1, and PQ2 (i.e., bitmask 00000111) with [1,1,2] weights. In response to the creation of the VQ entry in the virtual queue table 205, the queue manager or similar software (e.g., a driver) allocates a set of physical queues based on the values defined in the virtual queue table. In one example, the system initiates 4096×2-KiB buffers and creates 4096 number of descriptors accordingly which are addressed by desc0-desc4095.

The user, operating system, or similar entity configures the flow steering on the NIC (Block 311). In some embodiments, by default, the NIC can use receive side scaling (RSS) or any other similar technique. However, a user, operating system, or similar entity can define and install rules on the NIC to distribute data packets or flows among the physical queues in a more controlled way.

There are at least three methods to install rules for implementing flow control steering on a NIC with virtual queue support. In one embodiment, the user, operating system, or similar entity defines or installs rules on virtual queues. In this case, the NIC uses a pre-defined process (e.g., round-robin) to distribute the packets matching this rule among the physical queues associated with the specified virtual queue by the user.

In another embodiment, the user, operating system, or similar entity defines or installs rules on physical queues 111. In this case, a user, operating system, or similar entity can give priorities to different rules installed on different physical queues 111 associated with one virtual queue, giving a more fine-grained control over packet classification and processing. In a further embodiment, it is possible to combine definition of rules on virtual queues with the definition of rules on physical queues together to have a hierarchical flow steering on the NIC 101, where any priority between the two sets of rules can be defined.

In one example embodiment, the operating system or user utilizes the combined hierarchical approach for flow steering. The entity installs a rule on VQ0 for an identified transmission control protocol (TCP) flow (FL1) categorizing data packets based a specific destination TCP port (DESCPORT1) and destination IP (DESCIP1), i.e., covering data packets illustrated with different shadings in FIG. 2. The operating system 211 can further define three different rules on the physical queues 201A associated with VQ0. The physical queue rules divide packets belonging to FL1 based on the incoming packets' source TPs (i.e., SRCIP1, SRCIP2, and SRCIP3). In this example, the TCP flow (FL1) only has three source Internet Protocol (IP) addresses represented with three different shadings in FIG. 2. The rule is set to send type 1 packet to PQ0, type 2 packet to PQ1, and type 3 packet to PQ2.

The operating system, user, or similar entity initializes the virtual/physical queues on the NIC, i.e., it provides the allocated addresses to the NIC queue manager 115. This can be done in at least two ways. In a first method, the operating system 211, user, or application decides on the number of addresses/buffers/descriptors for every physical queue. The entity initializes each physical queue independently. In a second method, the operating system 211, user, application, or similar entity provides a set of addresses to the NIC 101 for a virtual queue, and then the queue manager 115 distributes those addresses among the physical queues 111 associated with that virtual queue depending on their weights. The entity thereby initializes the physical queues indirectly.

In one example using the second method, an entire set of 4096 descriptors (i.e., desc0-desc4095) can be provided to NIC 101 (i.e., queue manager 115). The queue manager 115 divides the descriptors with the weight of [2,1,1] for the virtual queue as specified in the entry for the virtual queue. This means 2048 descriptors (i.e., desc0-desc1023) are set to be used by PQ0; 1024 descriptors are set to be used by PQ1 (i.e., desc1024-desc2047); and 2048 descriptors are set to be used by PQ2 (i.e., desc2048-desc4095).

In some embodiments, the operating system 211 performs required actions to set up interrupt/polling depending on the selected mode by the application or operating system. In one example, a Linux OS associates an interrupt number to each queue and then assigns cores for handling each interrupt number (e.g., it configures IRQ affinity). In some embodiments, the PCIe poll request is not changed. However, in other embodiments, involving modified PCIe poll requests, the device driver has to choose the right format accordingly. In the example of FIG. 2 there is no change in the PCIe poll request. The system is set to poll the VQ0.

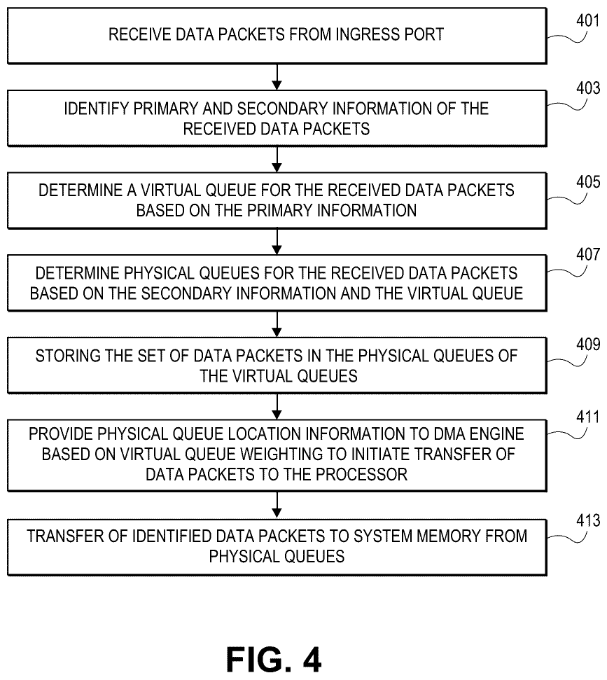

FIG. 4 is a flowchart of one embodiment of a process for data packet reception. The flowchart illustrates the different actions done by the NIC when it receives a data packet. The process can be initiated in response to receiving a set of data packets at an ingress port (Block 401). Any number of data packets can be received at each ingress port. For sake of clarity and conciseness, the example is explained in terms of a NIC handling a single ingress port receiving a set of data packets. However, one skilled in the art would appreciate that the processes and structures can be applied to any number of NICS, ingress ports, and data packets, which can be handled consistent with the principles described herein. The data packets received at the ingress port are received by the NIC to be processed.

The NIC manager, e.g., a parser module identifies the type of the packet based on the available information in the data packet (e.g., header and related information) and supported protocols by the NIC (e.g., IB, Ethernet, IP, TCP, user datagram protocol (UDP) or similar protocols) (Block 403). The information identified can be categorized as primary and secondary information, which is utilized to determine the virtual and physical queues for each data packet.

In the example illustrated in FIG. 2, the NIC 101 has received a series of data packets (e.g., Ethernet packets) (represented with different shading) from TCP flow (FL1) with different source IP Addresses (SRCIP1=type 1, SRCIP2=type 2, and SRCIP3=type 3). The NIC manager 107 (e.g., queueing module 115) or any other module responsible for classifying packets uses the primary and secondary information and available information on the queue manager 115 to select the appropriate VQ and/or PQ for the incoming data packet. The latter information contains the already available data related to flow steering (e.g., RSS and defined rules in the initialization phase) and the number of available physical queues. In the embodiments, the number of physical queues can be obtained from the VQ table.

In the illustrated example, the NIC manager 107 processes the installed rules as follows: First, the NIC manager 107 identifies that the incoming packets (types 1-3) belong to the VQ0 (Block 405). Subsequently, the NIC manager 107 or queue manager 115 matches those packets against the physical queue rules defined for VQ0 (Block 407) and puts the received packets in appropriate PQs, i.e., type 1 packet in PQ0, type 2 packets in PQ1, and type 3 packet in PQ2 (Block 409).

The NIC manager 107 (e.g., the scheduler) retrieves the descriptor addresses associated with each VQ and/or PQ from the queue manager 115 (based on the weight list defined in the VQ table) and provides a list of addresses and their respective VQ/PQ to the DMA engine 109 to start transferring the received packets into the working memory for the processors (e.g., system memory) (Block 411). The embodiments are compatible with the DMA engine 109 that perform simultaneous transactions to transfer the data packets to the working memory for the processors (Block 413). In some embodiments, the PQ weight list affects the outcome of polling and data transfer. The scheduler can support the PQ weight list to schedule DMA operations. In the example, the NIC manager provides a list of descriptors for PQ0, PQ1, and PQ2 according to the defined weight, i.e., two packets from PQ2 (two green), one packet from PQ1 (one light blue), and one packet from PQ0 (one red) to the DMA engine. The DMA engine fetches packets from PQs and transfers them to system memory. In addition, DMA engine passes the list of successfully transferred packets to the relevant entity, e.g., NIC manger (scheduler) and thereby to make them available to the processors.

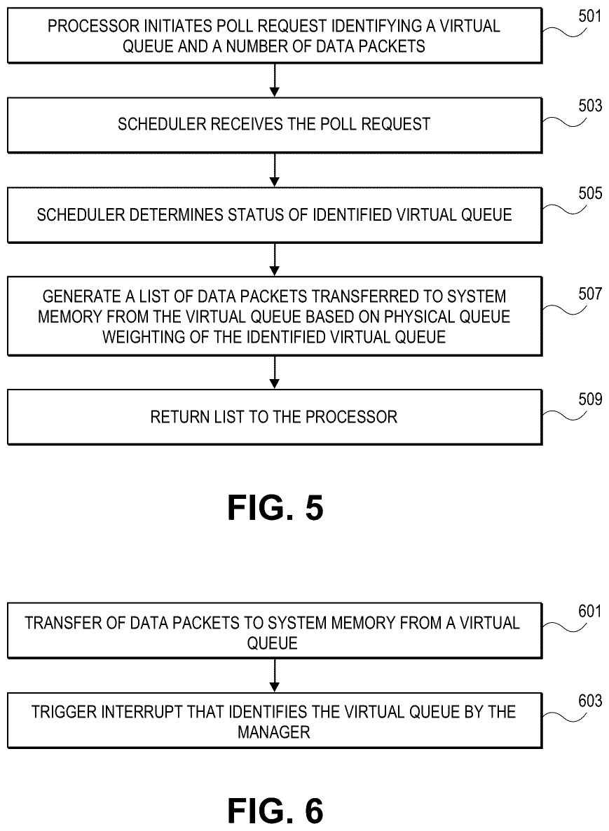

The embodiments further included processes for I/O event handling. FIG. 5 is a flowchart of one embodiment of a process for polling. In this example process, the operating system, processors, and NIC manager are configured to utilize the polling method. The different steps taken to poll the NIC to receive packets can be executed on a per processor, or per processor core basis. Each processor or processor core can initiate a poll request (e.g., a PCIe poll request or a check of a data structure in the cache or memory that holds I/O status information for the transfer of data packets to the memory) identifying a VQ (Block 501). The poll requests contain a queue ID field that could be interpreted as PQ ID or VQ ID. In the embodiments, this field is used to represent the VQ ID. In one example, processor core CO sends a PCIe poll request for VQ0 for up to 4 packets. The NIC manager or scheduler receives the polling request and identifies the VQ ID of the polling request (Block 503). In the example, the scheduler or NIC manager receives a polling request for VQ0.

The NIC manager or scheduler determines the status of the polled VQ and consequently its sub-physical queues. There can be different implementations to perform the inquiry regarding DMA transferred packets. Two possible options include querying the queue manager and querying the DMA engine or any other entity that can be configured to keep track of the successful DMA transferred packets. In one example, the NIC manager determines that all packets in the requested VQ (e.g., 2 from PQ2, 1 from PQ1, and 1 from PQ0) have been successfully DMA transferred to the working memory to the processors. The NIC manager or scheduler module prepares a list of buffers and their respective addresses/descriptors of the working memory space for the successfully DMA transferred packets (Block 507), creates the right reply for the received PCIe poll request, and sends the reply to requesting entity (e.g., processor, processor core or similar entity (Block 509). In some implementations, the reply can be sent by DMA engine 109 (i.e., as a communication gateway of NIC).

If the PQ weight list is non uniform, the response to the polling request takes into account the right order and fetch priority for the different PQs when providing addresses to the host. In one example, the NIC manager creates a list of 4 packets (i.e., 2 from PQ2, 1 from PQ1, and 1 from PQ0) along with their addresses and gives it to the DMA engine. The DMA engine sends this reply to the requesting entity.

FIG. 6 is a diagram of one embodiment of a process of using interrupts to manage I/O events. Although the focus of the embodiments has been on polling embodiments, the embodiments are also compatible with use of interrupts. When a polling mechanism is used, the polling mechanism targets high-performance and low-latency applications running at multi-hundred-gigabit rates.

At the time of initialization, the NIC can be configured with interrupts enabled and virtual queues established for groupings of physical queues, e.g., VQ0 backed by PQ0, PQ1, PQ2. The process also receives proper configuration for how to handle the interrupt for each virtual queue. For example, this can mean that transfers from VQ0 will be used to trigger the associated interrupt. Thus, after configuration of an interrupt that correlates with each virtual queue, a transfer of data of a given virtual queue to the working memory (Block 601), triggers the corresponding interrupt that identifies the associated virtual queue from which the interrupt was generated (Block 603). The packet reception will be the same as polling process.

In some example embodiments, upon successful transmission of packets from the NIC to the working memory, the NIC manager triggers an interrupt to the operating system. The criteria for triggering an interrupt may be different for different vendors. For instance, a device may wait for a few successful DMA transfers before raising an interrupt. In Linux operating system, every queue has a specific interrupt number, which will be handled by a specific processor core depending on the operating system policy. For instance, new kernels make it possible to assign each interrupt number to a specific processor core via SMP IRQ affinity or to balance the interrupts among processor cores via IRQ balance functionality.

When a processor core receives an interrupt, it performs a context switch (to kernel mode) to handle the interrupt and process the incoming packet. In the embodiments, an interrupt number specifies a VQ rather than a PQ, which makes it possible to seamlessly connect multiple PQs to a single processor or processor core.

In some embodiments, there will be two changes in the NIC, operating system, or related components. First, the system/OS defines interrupt numbers and IRQ for VQs rather than PQs during the initialization phase. Second, the NIC triggers interrupt at the granularity of VQs rather than PQs. In other words, if any of the PQs associated with one VQ received a data packet or combinations of all PQs receive certain number of packets (defined as trigger point for interrupt), the operating system will receive an interrupt for one VQ.

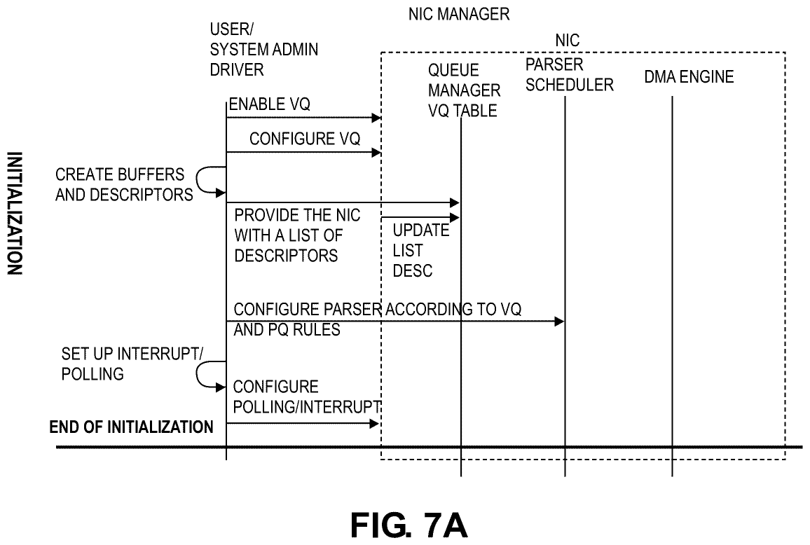

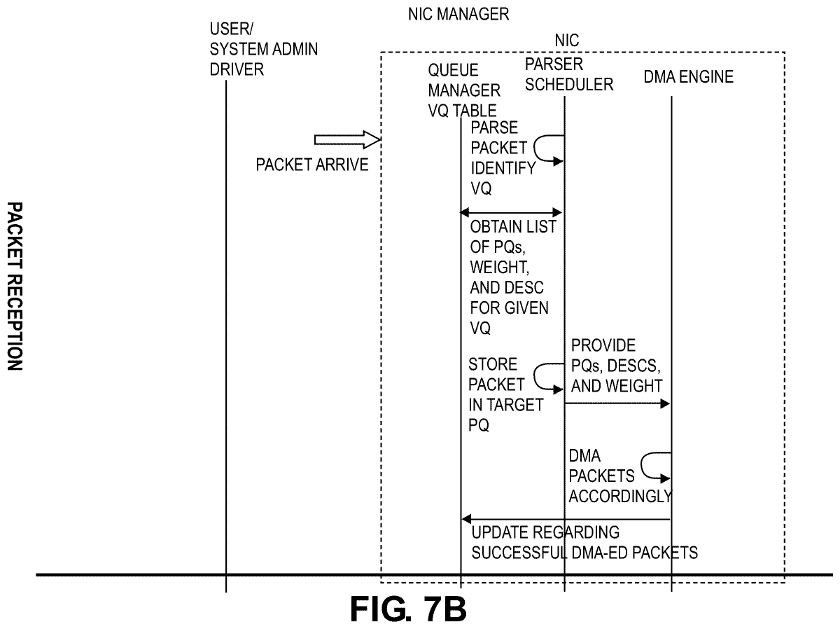

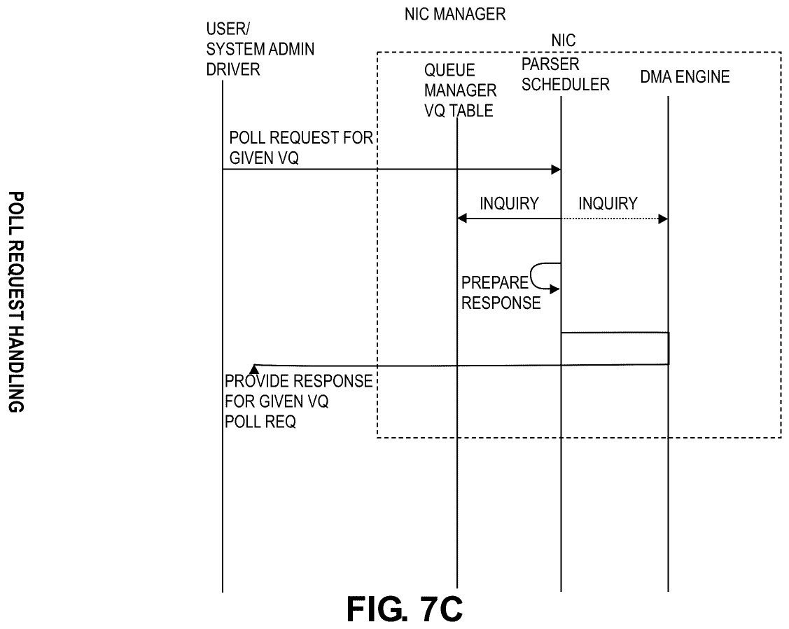

FIGS. 7A-C are timing diagrams of one embodiment illustrating the operation of components of processes for virtual queue management. The diagrams illustrate signaling and interactions in three independent phases, initialization, packet reception, and polling requests. The embodiments of the timing diagram are an example overview of the interactions of the components provided by way of example and not limitation. Those skilled in the art would appreciate that the functions of the processes of the embodiments can differently distributed and the components differently configured consistent with the principles and structures of the embodiments.

In the example embodiment of FIG. 7A, the initialization is started by a user such as a system administrator, or a function of an operating system (e.g., a driver) enabling virtual queueing by sending a configuration message or signal to a NIC manager or similar component. Other general settings of the configuration can be established for the NIC by configuration messages or signaling for example to establish virtual queue tables.

Similarly, the user, system administrator, operating system or similar entity can define and sends configuration information to the NIC manager to create and correlate virtual queues with physical queues as well as designating weights for the physical queues. In some embodiments, this can be in the form of descriptors and lists that are sent to the NIC manager, which are further passed to a queue manager or similar component therein.

The user, administrator, operating system or similar entity can define and send parsing rules to be implemented as either virtual queue rules or physical queue rules. In some embodiments these rules are passed to the parser or scheduler of the NIC manager to be implemented on incoming data packets to identify different types of data packets and assign them to different physical queues associated with various virtual queues.

In some embodiments, the user, administrator, operating system or similar entity can configure the NIC manager to use polling requests or interrupts to interact with the consumers of the data packets (e.g., processors, processor cores, or similar components). With each of the configuration actions completed, the initialization phase can complete. The initialization phase can be done at the startup of the electronic device implementing the virtual queue processes or in response to user, administrator, operating system or similar entity interactions with the electronic devices and the NIC manager.

FIG. 7B is a timing diagram of the packet receptions phase. The packet reception phase can operate or be triggered in response to receiving data packets on the ingress ports (e.g., wired or wireless) of the electronic device executing the virtual queueing processes. The data packets are received by the NIC manager and parsed by the parser or similar component of the NIC manager. The parser identifies primary and secondary information about the type of the data packet. The primary information is utilized to correlate the data packet with a virtual queue. The secondary information is utilized to correlate the data packet with a physical queue that is assigned or grouped with the virtual queue. The primary and secondary information can be any information in the data packet or derived therefrom. The user, administrator, operating system or similar entity can configure the primary and secondary information as part of defining the virtual queue tables, entries, or rules in the initialization phase.

Once the primary information is identified by the parser, the virtual queue table can be accessed to obtain the list of physical queues, physical queue weights, and descriptors for the virtual queue. This data can then be used along with the secondary information to identify a physical queue into which the data packet is to be stored and to store the data packet accordingly. The location of the stored data packet based on descriptors and similar information identifying the location of the stored data packet can be provided to the DMA engine or similar component to enable the transfer of the data packet either by polling request/interrupt and DMA transfer.

The data packets are transferred by DMA to working memory for the consumers of the data packets by the DMA engine. The DMA engine can notify the queue manager or other components of the NIC manager that the data packets have been successfully transferred to the working memory. This can initiate an interrupt if the interrupt mode is enabled. In cases where polling is activated, then the queue manager or similar component can service the polling requests of the consumers (e.g., processors or processor cores).

FIG. 7C is a timing diagram of the polling request handling phase. This phase can be initiated by a consumer of data packets such as a processor or processor core in a network device. The consumer sends a polling request for data packets to the NIC manager (e.g., to a scheduler) that identifies a specific virtual queue. The scheduler can query a queue manager, DMA engine or similar component that tracks the data packet locations and related information for the identified virtual queue to determine whether there are data packets to be processed. The queue manager or DMA engine can identify the data packets that are available as well as the priority thereof to fulfill the polling request. The data packet information can then be marshalled including location information and descriptors that are then sent as part of a response to the polling request to the consumer or similar originator of the polling request.

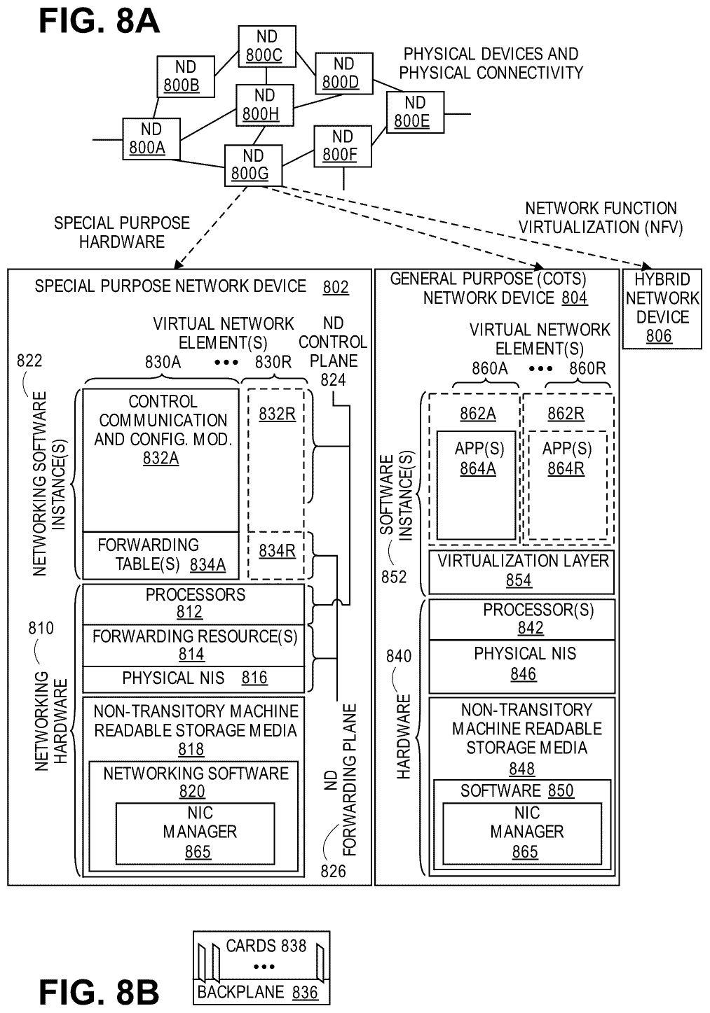

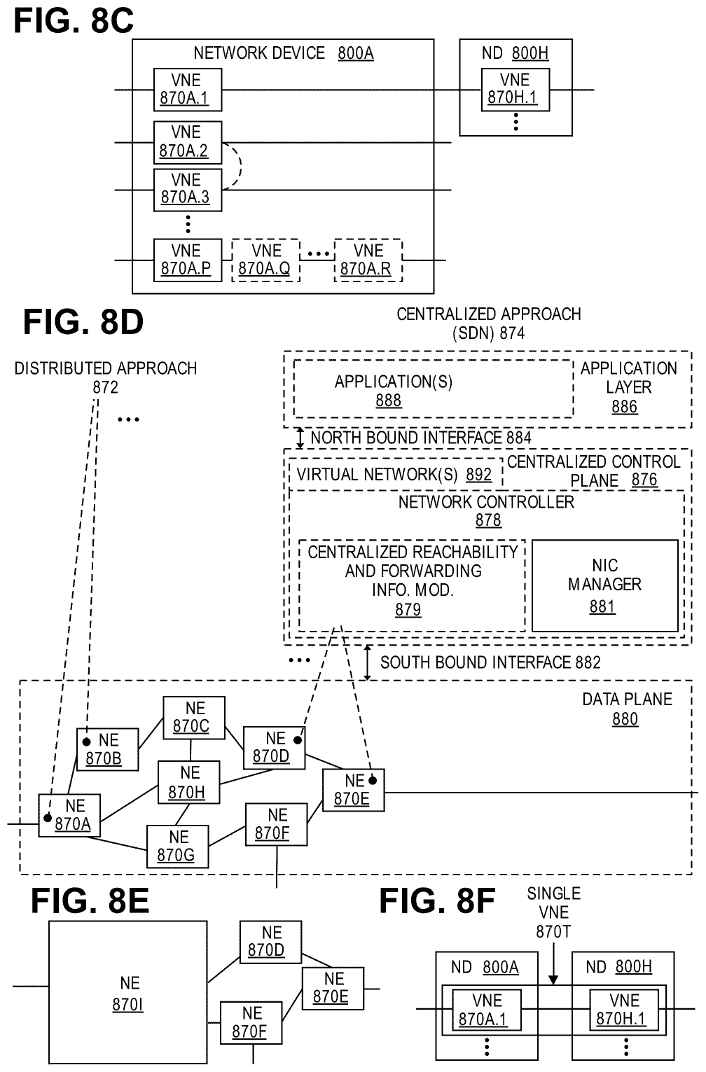

FIG. 8A illustrates connectivity between network devices (NDs) within an exemplary network, as well as three exemplary implementations of the NDs, according to some embodiments of the invention. FIG. 8A shows NDs 800A-H, and their connectivity by way of lines between 800A-800B, 800B-800C, 800C-800D, 800D-800E, 800E-800F, 800F-800G, and 800A-800G, as well as between 800H and each of 800A, 800C, 800D, and 800G. These NDs are physical devices, and the connectivity between these NDs can be wireless or wired (often referred to as a link). An additional line extending from NDs 800A, 800E, and 800F illustrates that these NDs act as ingress and egress points for the network (and thus, these NDs are sometimes referred to as edge NDs; while the other NDs may be called core NDs).

Two of the exemplary ND implementations in FIG. 8A are: 1) a special-purpose network device 802 that uses custom application-specific integrated-circuits (ASICs) and a special-purpose operating system (OS); and 2) a general purpose network device 804 that uses common off-the-shelf (COTS) processors and a standard OS.

The special-purpose network device 802 includes networking hardware 810 comprising a set of one or more processor(s) 812, forwarding resource(s) 814 (which typically include one or more ASICs and/or network processors), and physical network interfaces (NIs) 816 (through which network connections are made, such as those shown by the connectivity between NDs 800A-H), as well as non-transitory machine readable storage media 818 having stored therein networking software 820. During operation, the networking software 820 may be executed by the networking hardware 810 to instantiate a set of one or more networking software instance(s) 822. Each of the networking software instance(s) 822, and that part of the networking hardware 810 that executes that network software instance (be it hardware dedicated to that networking software instance and/or time slices of hardware temporally shared by that networking software instance with others of the networking software instance(s) 822), form a separate virtual network element 830A-R. Each of the virtual network element(s) (VNEs) 830A-R includes a control communication and configuration module 832A-R (sometimes referred to as a local control module or control communication module) and forwarding table(s) 834A-R, such that a given virtual network element (e.g., 830A) includes the control communication and configuration module (e.g., 832A), a set of one or more forwarding table(s) (e.g., 834A), and that portion of the networking hardware 810 that executes the virtual network element (e.g., 830A).

In some embodiments, the networking software 820 or similar software can include a NIC manager 865 or similar components and sub-components. The NIC manager 865 can perform the operations of the virtual queue management processes described herein.

The special-purpose network device 802 is often physically and/or logically considered to include: 1) a ND control plane 824 (sometimes referred to as a control plane) comprising the processor(s) 812 that execute the control communication and configuration module(s) 832A-R; and 2) a ND forwarding plane 826 (sometimes referred to as a forwarding plane, a data plane, or a media plane) comprising the forwarding resource(s) 814 that utilize the forwarding table(s) 834A-R and the physical NIs 816. By way of example, where the ND is a router (or is implementing routing functionality), the ND control plane 824 (the processor(s) 812 executing the control communication and configuration module(s) 832A-R) is typically responsible for participating in controlling how data (e.g., packets) is to be routed (e.g., the next hop for the data and the outgoing physical NI for that data) and storing that routing information in the forwarding table(s) 834A-R, and the ND forwarding plane 826 is responsible for receiving that data on the physical NIs 816 and forwarding that data out the appropriate ones of the physical NIs 816 based on the forwarding table(s) 834A-R.

FIG. 8B illustrates an exemplary way to implement the special-purpose network device 802 according to some embodiments of the invention. FIG. 8B shows a special-purpose network device including cards 838 (typically hot pluggable). While in some embodiments the cards 838 are of two types (one or more that operate as the ND forwarding plane 826 (sometimes called line cards), and one or more that operate to implement the ND control plane 824 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 836 (e.g., a first full mesh coupling the line cards and a second full mesh coupling all of the cards).

Returning to FIG. 8A, the general purpose network device 804 includes hardware 840 comprising a set of one or more processor(s) 842 (which are often COTS processors) and physical NIs 846, as well as non-transitory machine readable storage media 848 having stored therein software 850. During operation, the processor(s) 842 execute the software 850 to instantiate one or more sets of one or more applications 864A-R. While one embodiment does not implement virtualization, alternative embodiments may use different forms of virtualization. For example, in one such alternative embodiment the virtualization layer 854 represents the kernel of an operating system (or a shim executing on a base operating system) that allows for the creation of multiple instances 862A-R called software containers that may each be used to execute one (or more) of the sets of applications 864A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 854 represents a hypervisor (sometimes referred to as a virtual machine monitor (VMM)) or a hypervisor executing on top of a host operating system, and each of the sets of applications 864A-R is run on top of a guest operating system within an instance 862A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 840, directly on a hypervisor (in which case the unikernel is sometimes described as running within a LibOS virtual machine), or in a software container, embodiments can be implemented fully with unikernels running directly on a hypervisor represented by virtualization layer 854, unikernels running within software containers represented by instances 862A-R, or as a combination of unikernels and the above-described techniques (e.g., unikernels and virtual machines both run directly on a hypervisor, unikernels and sets of applications that are run in different software containers).

In some embodiments, the software 850 or similar software can include a NIC manager 865 or similar components and sub-components. The NIC manager 865 can perform the operations of the virtual queue management processes described herein.

The instantiation of the one or more sets of one or more applications 864A-R, as well as virtualization if implemented, are collectively referred to as software instance(s) 852. Each set of applications 864A-R, corresponding virtualization construct (e.g., instance 862A-R) if implemented, and that part of the hardware 840 that executes them (be it hardware dedicated to that execution and/or time slices of hardware temporally shared), forms a separate virtual network element(s) 860A-R.

The virtual network element(s) 860A-R perform similar functionality to the virtual network element(s) 830A-R—e.g., similar to the control communication and configuration module(s) 832A and forwarding table(s) 834A (this virtualization of the hardware 840 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 862A-R corresponding to one VNE 860A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 862A-R to VNEs also apply to embodiments where such a finer level of granularity and/or unikernels are used.

In certain embodiments, the virtualization layer 854 includes a virtual switch that provides similar forwarding services as a physical Ethernet switch. Specifically, this virtual switch forwards traffic between instances 862A-R and the physical NI(s) 846, as well as optionally between the instances 862A-R; in addition, this virtual switch may enforce network isolation between the VNEs 860A-R that by policy are not permitted to communicate with each other (e.g., by honoring virtual local area networks (VLANs)).

The third exemplary ND implementation in FIG. 8A is a hybrid network device 806, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 802) could provide for para-virtualization to the networking hardware present in the hybrid network device 806.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 830A-R, VNEs 860A-R, and those in the hybrid network device 806) receives data on the physical NIs (e.g., 816, 846) and forwards that data out the appropriate ones of the physical NIs (e.g., 816, 846). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 8C illustrates various exemplary ways in which VNEs may be coupled according to some embodiments of the invention. FIG. 8C shows VNEs 870A.1-870A.P (and optionally VNEs 870A.Q-870A.R) implemented in ND 800A and VNE 870H.1 in ND 800H. In FIG. 8C, VNEs 870A.1-P are separate from each other in the sense that they can receive packets from outside ND 800A and forward packets outside of ND 800A; VNE 870A.1 is coupled with VNE 870H.1, and thus they communicate packets between their respective NDs; VNE 870A.2-870A.3 may optionally forward packets between themselves without forwarding them outside of the ND 800A; and VNE 870A.P may optionally be the first in a chain of VNEs that includes VNE 870A.Q followed by VNE 870A.R (this is sometimes referred to as dynamic service chaining, where each of the VNEs in the series of VNEs provides a different service—e.g., one or more layer 4-7 network services). While FIG. 8C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 8A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 8A may also host one or more such servers (e.g., in the case of the general purpose network device 804, one or more of the software instances 862A-R may operate as servers; the same would be true for the hybrid network device 806; in the case of the special-purpose network device 802, one or more such servers could also be run on a virtualization layer executed by the processor(s) 812); in which case the servers are said to be co-located with the VNEs of that ND.

A virtual network is a logical abstraction of a physical network (such as that in FIG. 8A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 8D illustrates a network with a single network element on each of the NDs of FIG. 8A, and within this straight forward approach contrasts a traditional distributed approach (commonly used by traditional routers) with a centralized approach for maintaining reachability and forwarding information (also called network control), according to some embodiments of the invention. Specifically, FIG. 8D illustrates network elements (NEs) 870A-H with the same connectivity as the NDs 800A-H of FIG. 8A.

FIG. 8D illustrates that the distributed approach 872 distributes responsibility for generating the reachability and forwarding information across the NEs 870A-H; in other words, the process of neighbor discovery and topology discovery is distributed.

For example, where the special-purpose network device 802 is used, the control communication and configuration module(s) 832A-R of the ND control plane 824 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 870A-H (e.g., the processor(s) 812 executing the control communication and configuration module(s) 832A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 824. The ND control plane 824 programs the ND forwarding plane 826 with information (e.g., adjacency and route information) based on the routing structure(s). For example, the ND control plane 824 programs the adjacency and route information into one or more forwarding table(s) 834A-R (e.g., Forwarding Information Base (FIB), Label Forwarding Information Base (LFIB), and one or more adjacency structures) on the ND forwarding plane 826. For layer 2 forwarding, the ND can store one or more bridging tables that are used to forward data based on the layer 2 information in that data. While the above example uses the special-purpose network device 802, the same distributed approach 872 can be implemented on the general purpose network device 804 and the hybrid network device 806.

FIG. 8D illustrates that a centralized approach 874 (also known as software defined networking (SDN)) that decouples the system that makes decisions about where traffic is sent from the underlying systems that forwards traffic to the selected destination. The illustrated centralized approach 874 has the responsibility for the generation of reachability and forwarding information in a centralized control plane 876 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 876 has a south bound interface 882 with a data plane 880 (sometime referred to the infrastructure layer, network forwarding plane, or forwarding plane (which should not be confused with a ND forwarding plane)) that includes the NEs 870A-H (sometimes referred to as switches, forwarding elements, data plane elements, or nodes). The centralized control plane 876 includes a network controller 878, which includes a centralized reachability and forwarding information module 879 that determines the reachability within the network and distributes the forwarding information to the NEs 870A-H of the data plane 880 over the south bound interface 882 (which may use the OpenFlow protocol). Thus, the network intelligence is centralized in the centralized control plane 876 executing on electronic devices that are typically separate from the NDs.

In some embodiments, the centralized control plane 876 or similar software can include a NIC manager 881 or similar components and sub-components or some portions thereof. The NIC manager 881 can perform the operations of the virtual queue management processes described herein. In further embodiments, the configuration of the NIC manager in the data plane 880 can be managed by a component of the centralized control plane 876.

For example, where the special-purpose network device 802 is used in the data plane 880, each of the control communication and configuration module(s) 832A-R of the ND control plane 824 typically include a control agent that provides the VNE side of the south bound interface 882. In this case, the ND control plane 824 (the processor(s) 812 executing the control communication and configuration module(s) 832A-R) performs its responsibility for participating in controlling how data (e.g., packets) is to be routed (e.g., the next hop for the data and the outgoing physical NI for that data) through the control agent communicating with the centralized control plane 876 to receive the forwarding information (and in some cases, the reachability information) from the centralized reachability and forwarding information module 879 (it should be understood that in some embodiments of the invention, the control communication and configuration module(s) 832A-R, in addition to communicating with the centralized control plane 876, may also play some role in determining reachability and/or calculating forwarding information—albeit less so than in the case of a distributed approach; such embodiments are generally considered to fall under the centralized approach 874, but may also be considered a hybrid approach).

While the above example uses the special-purpose network device 802, the same centralized approach 874 can be implemented with the general purpose network device 804 (e.g., each of the VNE 860A-R performs its responsibility for controlling how data (e.g., packets) is to be routed (e.g., the next hop for the data and the outgoing physical NI for that data) by communicating with the centralized control plane 876 to receive the forwarding information (and in some cases, the reachability information) from the centralized reachability and forwarding information module 879; it should be understood that in some embodiments of the invention, the VNEs 860A-R, in addition to communicating with the centralized control plane 876, may also play some role in determining reachability and/or calculating forwarding information—albeit less so than in the case of a distributed approach) and the hybrid network device 806. In fact, the use of SDN techniques can enhance the NFV techniques typically used in the general purpose network device 804 or hybrid network device 806 implementations as NFV is able to support SDN by providing an infrastructure upon which the SDN software can be run, and NFV and SDN both aim to make use of commodity server hardware and physical switches.

FIG. 8D also shows that the centralized control plane 876 has a north bound interface 884 to an application layer 886, in which resides application(s) 888. The centralized control plane 876 has the ability to form virtual networks 892 (sometimes referred to as a logical forwarding plane, network services, or overlay networks (with the NEs 870A-H of the data plane 880 being the underlay network)) for the application(s) 888. Thus, the centralized control plane 876 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 8D shows the distributed approach 872 separate from the centralized approach 874, the effort of network control may be distributed differently or the two combined in certain embodiments of the invention. For example: 1) embodiments may generally use the centralized approach (SDN) 874, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 874, but may also be considered a hybrid approach.

While FIG. 8D illustrates the simple case where each of the NDs 800A-H implements a single NE 870A-H, it should be understood that the network control approaches described with reference to FIG. 8D also work for networks where one or more of the NDs 800A-H implement multiple VNEs (e.g., VNEs 830A-R, VNEs 860A-R, those in the hybrid network device 806). Alternatively or in addition, the network controller 878 may also emulate the implementation of multiple VNEs in a single ND. Specifically, instead of (or in addition to) implementing multiple VNEs in a single ND, the network controller 878 may present the implementation of a VNE/NE in a single ND as multiple VNEs in the virtual networks 892 (all in the same one of the virtual network(s) 892, each in different ones of the virtual network(s) 892, or some combination). For example, the network controller 878 may cause an ND to implement a single VNE (a NE) in the underlay network, and then logically divide up the resources of that NE within the centralized control plane 876 to present different VNEs in the virtual network(s) 892 (where these different VNEs in the overlay networks are sharing the resources of the single VNE/NE implementation on the ND in the underlay network).

On the other hand, FIGS. 8E and 8F respectively illustrate exemplary abstractions of NEs and VNEs that the network controller 878 may present as part of different ones of the virtual networks 892. FIG. 8E illustrates the simple case of where each of the NDs 800A-H implements a single NE 870A-H (see FIG. 8D), but the centralized control plane 876 has abstracted multiple of the NEs in different NDs (the NEs 870A-C and G-H) into (to represent) a single NE 8701 in one of the virtual network(s) 892 of FIG. 8D, according to some embodiments of the invention. FIG. 8E shows that in this virtual network, the NE 8701 is coupled to NE 870D and 870F, which are both still coupled to NE 870E.

FIG. 8F illustrates a case where multiple VNEs (VNE 870A.1 and VNE 870H.1) are implemented on different NDs (ND 800A and ND 800H) and are coupled to each other, and where the centralized control plane 876 has abstracted these multiple VNEs such that they appear as a single VNE 870T within one of the virtual networks 892 of FIG. 8D, according to some embodiments of the invention. Thus, the abstraction of a NE or VNE can span multiple NDs.

While some embodiments of the invention implement the centralized control plane 876 as a single entity (e.g., a single instance of software running on a single electronic device), alternative embodiments may spread the functionality across multiple entities for redundancy and/or scalability purposes (e.g., multiple instances of software running on different electronic devices).

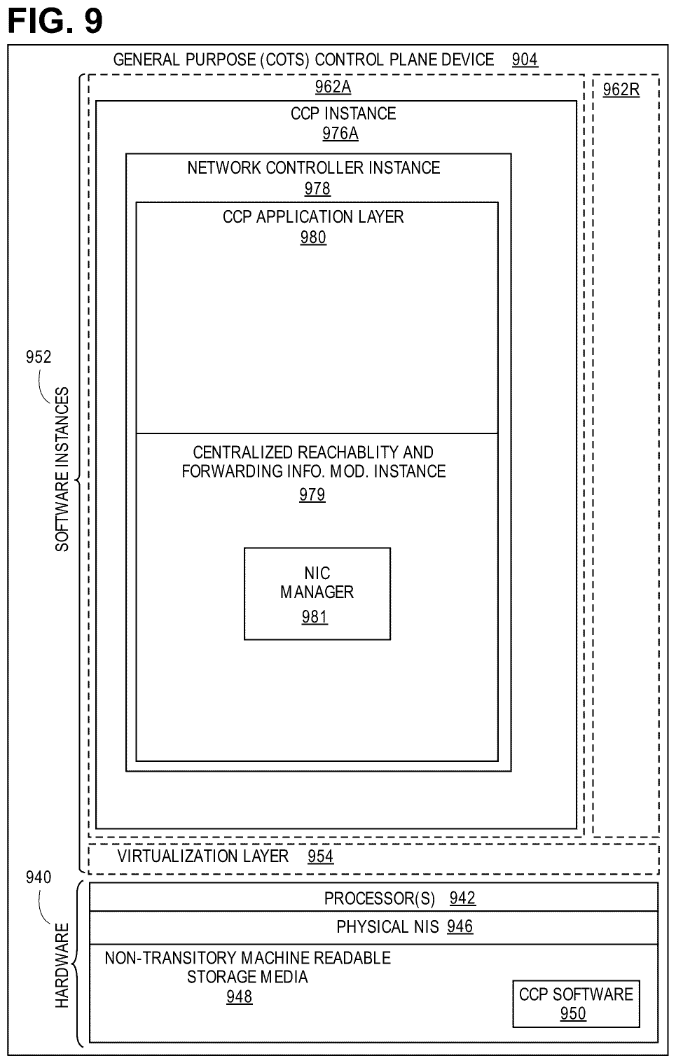

Similar to the network device implementations, the electronic device(s) running the centralized control plane 876, and thus the network controller 878 including the centralized reachability and forwarding information module 879, may be implemented a variety of ways (e.g., a special purpose device, a general-purpose (e.g., COTS) device, or hybrid device). These electronic device(s) would similarly include processor(s), a set or one or more physical NIs, and a non-transitory machine-readable storage medium having stored thereon the centralized control plane software. For instance, FIG. 9 illustrates, a general purpose control plane device 904 including hardware 940 comprising a set of one or more processor(s) 942 (which are often COTS processors) and physical NIs 946, as well as non-transitory machine readable storage media 948 having stored therein centralized control plane (CCP) software 950.

In some embodiments, the centralized control plane software 950 or similar software can include a NIC manager 981 or similar components and sub-components or some portions thereof. The NIC manager 981 can perform the operations of the virtual queue management processes described herein. In further embodiments, the configuration of the NIC manager in the data plane 880 can be managed by a component of the centralized control plane software 950.

In embodiments that use compute virtualization, the processor(s) 942 typically execute software to instantiate a virtualization layer 954 (e.g., in one embodiment the virtualization layer 954 represents the kernel of an operating system (or a shim executing on a base operating system) that allows for the creation of multiple instances 962A-R called software containers (representing separate user spaces and also called virtualization engines, virtual private servers, or jails) that may each be used to execute a set of one or more applications; in another embodiment the virtualization layer 954 represents a hypervisor (sometimes referred to as a virtual machine monitor (VMM)) or a hypervisor executing on top of a host operating system, and an application is run on top of a guest operating system within an instance 962A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 940, directly on a hypervisor represented by virtualization layer 954 (in which case the unikernel is sometimes described as running within a LibOS virtual machine), or in a software container represented by one of instances 962A-R). Again, in embodiments where compute virtualization is used, during operation an instance of the CCP software 950 (illustrated as CCP instance 976A) is executed (e.g., within the instance 962A) on the virtualization layer 954. In embodiments where compute virtualization is not used, the CCP instance 976A is executed, as a unikernel or on top of a host operating system, on the “bare metal” general purpose control plane device 904. The instantiation of the CCP instance 976A, as well as the virtualization layer 954 and instances 962A-R if implemented, are collectively referred to as software instance(s) 952.

In some embodiments, the CCP instance 976A includes a network controller instance 978. The network controller instance 978 includes a centralized reachability and forwarding information module instance 979 (which is a middleware layer providing the context of the network controller 878 to the operating system and communicating with the various NEs), and an CCP application layer 980 (sometimes referred to as an application layer) over the middleware layer (providing the intelligence required for various network operations such as protocols, network situational awareness, and user—interfaces). At a more abstract level, this CCP application layer 980 within the centralized control plane 876 works with virtual network view(s) (logical view(s) of the network) and the middleware layer provides the conversion from the virtual networks to the physical view.

The centralized control plane 876 transmits relevant messages to the data plane 880 based on CCP application layer 980 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 880 may receive different messages, and thus different forwarding information. The data plane 880 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 880, the packet (or a subset of the packet header and content) is typically forwarded to the centralized control plane 876. The centralized control plane 876 will then program forwarding table entries into the data plane 880 to accommodate packets belonging to the flow of the unknown packet. Once a specific forwarding table entry has been programmed into the data plane 880 by the centralized control plane 876, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path—multiple equal cost next hops), some additional criteria is used—for instance, in a connectionless network, Equal Cost Multi Path (ECMP) (also known as Equal Cost Multi Pathing, multipath forwarding and IP multipath) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

For example, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method of buffering data packets at a network device, the method comprising:
receiving a set of data packets from an ingress port of the network device;
identifying primary information and secondary information about each data packet in the set of data packets;
determining a virtual queue for each data packet in the set of data packets based on the primary information, the virtual queue having a set of physical queues;
determining a physical queue from the set of physical queues for each of the data packets in the set of data packets based on the secondary information; and
storing the set of data packets in physical queues of the virtual queue.

2. The method of claim 1, further comprising:
providing location information for the set of physical queues to a direct memory access (DMA) engine based on virtual queue weighting.

3. The method of claim 2, further comprising:
transferring the set of data packets from the set of physical queues to system memory by the DMA engine to be processed by a processor of the network device.

4. The method of claim 1, further comprising:
establishing a virtual queue table; and
creating an entry in the virtual queue table for the virtual queue including at least one field for the set of physical queues.

5. The method of claim 4, further comprising:
setting a weighting of the set of physical queues in the entry, the weighting indicating a relative proportion of the set of data packets to process from each of the set of physical queues; and
configuring a flow steering mechanism of the network device according to the weighting.

6. The method of claim 1, further comprising:
receiving a polling request from a processor of the network device, the polling request identifying the virtual queue and a number of data packets to be serviced.

7. The method of claim 6, wherein the polling request is a peripheral component interconnect express (PCIe) read or a read or a check of a status value in memory.

8. The method of claim 6, further comprising:
determining a status of the virtual queue;
generating a list of data packets transferred to system memory from the virtual queue based on physical queue weighting for the set of physical queues; and
returning the list of data packets to the processor.

9. The method of claim 1, further comprising:
triggering an interrupt to a processor of the network device, where the interrupt identifies the virtual queue in response to a transfer of the set of data packets to system memory for the virtual queue.

10. A non-transitory machine-readable medium comprising computer program code which when executed by an electronic device causes the electronic device to carry out a set of operations of a method of buffering data packets at a network device, the set of operations comprising:
receiving a set of data packets from an ingress port of the network device;
identifying primary information and secondary information about each data packet in the set of data packets;
determining a virtual queue for each data packet in the set of data packets based on the primary information, the virtual queue having a set of physical queues;
determining a physical queue from the set of physical queues for each of the data packets in the set of data packets based on the secondary information; and
storing the set of data packets in physical queues of the virtual queue.

11. An electronic device configured to perform a method of buffering data packets, the electronic device comprising:
a system memory;
a processor; and
a network interface card configured to execute a queue manager configured to perform the method of buffering data packets, comprising:
receiving a set of data packets from an ingress port of the network interface card;
identifying primary information and secondary information about each data packet in the set of data packets;
determining a virtual queue for each data packet in the set of data packets based on the primary information, the virtual queue having a set of physical queues;
determining a physical queue from the set of physical queues for each of the data packets in the set of data packets based on the secondary information; and
storing the set of data packets in physical queues of the virtual queue.

12. The electronic device of claim 11, wherein the queue manager is further configured to provide location information for the set of physical queues to a direct memory access (DMA) engine based on virtual queue weighting.

13. The electronic device of claim 12, wherein the queue manager is further configured to transfer the set of data packets from the set of physical queues to system memory by the DMA engine to be processed by the processor.

14. The electronic device of claim 11, wherein the queue manager is further configured to:
establish a virtual queue table; and
create an entry in the virtual queue table for the virtual queue including at least one field for the set of physical queues.

15. The electronic device of claim 14, wherein the queue manager is further configured to:
set a weighting of the set of physical queues in the entry, the weighting indicating a relative proportion of the set of data packets to process from each of the set of physical queues; and
configure a flow steering mechanism of the electronic device according to the weighting.

16. The electronic device of claim 11, wherein the queue manager is further configured to receive a polling request from the processor, the polling request identifying the virtual queue and a number of data packets to be serviced.

17. The electronic device of claim 16, wherein the polling request is a peripheral component interconnect express (PCIe) read or a read or a check of a status value in memory.

18. The electronic device of claim 16, wherein the queue manager is further configured to:
determine a status of the virtual queue;
generate a list of data packets transferred to the system memory from the virtual queue based on physical queue weighting for the set of physical queues; and
return the list of data packets to the processor.

19. The electronic device of claim 11, wherein the queue manager is further configured to trigger an interrupt to the processor of the network device, where the interrupt identifies the virtual queue in response to a transfer of the set of data packets to the system memory.
